(19) United States
(12) Patent Application Publication
(10) Pub. No.: US 2013/0168567 A1
(43) Pub. Date: Jul. 4, 2013

(54) COLLIMATOR FOR A PIXELATED DETECTOR

(71) Applicants: Nurit Wartski, Tirat Carmel (IL); Ira Blevis, Tirat Carmel (IL); Nesma Bishara, Tirat Carmel (IL)

(72) Inventors: Nurit Wartski, Tirat Carmel (IL); Ira Blevis, Tirat Carmel (IL); Nesma Bishara, Tirat Carmel (IL)

(73) Assignee: GENERAL ELECTRIC COMPANY, Schenectady, NY (US)

(21) Appl. No.: 13/338,930

(22) Filed: Dec. 28, 2011

(51) Int. Cl. G01T 1/17; G21K 1/02

(52) U.S. Cl. 250/394; 250/505.1

(57) ABSTRACT

A collimator for collimating high-energy photons, which may be used in medical imaging (e.g., nuclear medicine). The collimator has holes through the thickness (height) of the collimator, with the holes arranged in groups or clusters. The collimator may be used with a detector having an array of pixels, wherein each group of holes may be associated with a corresponding pixel, thereby providing multiple collimator holes per pixel. In one embodiment, each group of holes has septa of a given width separating the holes in that group, and each group of holes is separated from neighboring groups by septa of another, greater width. In another embodiment, the intra-group septa may be recessed from the top and/or bottom surface(s) of the collimator such that these septa have a smaller thickness (height) than the inter-group septa.

### BACKGROUND OF THE INVENTION

The present invention relates generally to collimators for collimating photons, and more particularly to collimators for collimating high-energy photons for use in medical imaging, such as in nuclear medicine.

In most forms of medical diagnostic imaging, images are created by one of two methods: transmission or emission. Transmission imaging occurs when radiation is directed through a patient and onto a radiation detector, such as when using X-rays in X-ray imaging (XR) or Computed Tomography imaging (CT). Emission imaging occurs when radiation in the form of a radiopharmaceutical is injected into a patient (or ingested or inhaled by the patient) and radioactive particles are emitted by the patient's body, such as when gamma photons are emitted and detected in Single Photon Emission Computed Tomography (SPECT) or Positron Emission Tomography (PET). In both transmission and emission imaging, the detectors used are selected based on their sensitivity to high energy photons of a certain energy which are used by that imaging modality, such as X-rays used in XR and CT (80-120 keV), or gamma rays used in SPECT (140 keV) or PET (511 keV).

These imaging modalities typically utilize collimators to help assure that the photons received by the detector are from within a known incidence angle with respect to the detector surface. Collimators are very well known within these imaging modalities, and come in various known configurations such as parallel hole, slant hole, converging, diverging, fan beam, cone beam, pinhole and multi-pinhole. The most common collimators (i.e., parallel hole, slant hole, converging, diverging, fan beam and cone beam) are essentially a collection of straight, narrow “tubes” that are typically much longer than the “hole” or channel of each tube. A given collimator of this type typically has all of its channels of a certain diameter (e.g., 2 mm) and a certain cross-sectional shape (e.g., square, round, hexagonal, triangular, etc.).

FIGS. 1-4 illustrate a conventional registered collimator 10 and pixelated detector 20 arrangement that is well known in the art. (Although the drawings show only a single detector module having a 4×4 pixel matrix for the sake of simplicity, those skilled in the art will appreciate that larger pixel matrices may be used, such as 16×16 or larger up to many hundreds, comprising multiple detector modules tiled together.) In this arrangement, the collimator 10 has holes or channels 12 defined in the collimator body by septa 14. These holes 12 are arranged so as to conform or register in a one-to-one relationship with respective pixels 22 in the detector array, such that the collimator hole pitch Pₕ (i.e., the hole-to-hole spacing) generally matches the detector pixel pitch Pₚ (i.e., the pixel-to-pixel spacing). The detector pixels 22 are usually placed as closely together as possible, with air gaps, potting, insulation, reflective material/coatings, electrical wiring or the like (or continuous detector material, such as in “monolithic”-type detectors) 24 separating adjacent pixels 22. (A known alternative to the pattern of discrete pixels illustrated in FIGS. 1-4 is to form the pixels by metal patterns on the backside of a continuous, monolithic detector (not shown), thereby creating multiple individual internal electric fields, and thus defining the pixels.) Each hole or channel 12 in the collimator 10 is typically situated so that its centroid or major axis coincides with the center of its associated detector pixel 22. Referring to FIGS. 3 and 4, the collimator channels 12 and septa 14 may be designed such that the hole length (lₕ) and width (wₕ) generally match the pixel length (lₚ) and width (wₚ), respectively, and the thickness (Tₛ) of the septum 14 generally matches the thickness (T_{g}) of the gap 24 separating adjacent pixels 22, thus making the hole pitch Pₕ generally equivalent to the pixel pitch Pₚ. Alternatively, the septum thickness Tₛ may be chosen independent of both the pixel pitch Pₚ and gap thickness (T_{g}), and instead may be chosen to have a minimum opacity to gamma rays.

Collimator septa 14 are typically made of lead, tungsten or other material that is effective at stopping or absorbing high energy photons. Collimators are typically constructed by connecting foils which when connected form the desired shape and size of channels, or by other well-known additive or subtractive fabrication techniques such as casting, machining or extruding.

In the design of collimators, a compromise is struck between sensitivity and resolution. This is because stronger collimation results in more blocking and better selected photons, and weaker collimation results in less blocking and less selected photons. Thus, with all other things being kept equal, sensitivity and resolution are inversely proportional to each other; as one is increased, the other generally decreases. With the increased use of pixelated detectors, there is a trend toward use of smaller, more densely packed detector pixels. However, the resolution-sensitivity tradeoff remains a limitation on overall image quality and performance. Prior art work by Weinmann et al. at the Mayo Clinic (see “Design of optimal collimation for dedicated molecular breast imaging systems”, Med. Phys. 36 (3), March 2009, 845-56) has shown a sensitivity improvement of about 18% at constant resolution and septal penetration if the pixel size can be reduced from 2.46 mm to 1.6 mm. However, pixel size is a factory process standard which is difficult and costly to change, and changes to smaller pixels may result in reduced detector efficiency from increased pixel boundary-to-area ratio, It would be better to find alternative optimization approaches that do not change pixel size.

It would be desirable, therefore, to provide an improved collimator design which overcomes the disadvantages discussed above, and which provides advantages that are lacking in the prior art.

### SUMMARY OF THE INVENTION

In a first embodiment of the present invention, there is provided a registered collimator having holes therein arranged in groups, wherein the holes within each group are separated by intra-group septa having a first thickness Tᵢₙₜᵣₐ and the groups are separated from one another by inter-group septa having a second thickness Tᵢₙₜₑᵣ. The collimator is adapted for use with a pixelated detector having multiple pixel elements, such that each of the groups of collimator holes may be registered with a respective one of the pixel elements.

In a second embodiment of the present invention, there is provided a collimator having holes therein arranged in groups, wherein the holes within each group are separated by intra-group septa having a first thickness Tᵢₙₜᵣₐ and wherein the groups are separated from one another by inter-group septa having a second thickness Tᵢₙₜₑᵣ, such that Tᵢₙₜᵣₐ<Tᵢₙₜₑᵣ.

In a third embodiment of the present invention, there is provided a collimator having a top surface, a bottom surface and an overall height H_{c} extending between the surfaces. The collimator has holes therein arranged in groups, wherein the holes within each group are separated by intra-group septa and the groups are separated from one another by inter-group septa. The intra-group septa have a height hₛ and are recessed from the top surface and/or the bottom surface of the collimator, such that hₛ<H_{c}. For example, hₛ may be about 0.8 H_{c}.

In each of the various embodiments, the collimator has multiple groups of collimator holes registered with at least some of the detector pixels on a one-group-to-one-pixel (i.e., multiple-holes-per-pixel) basis, rather than simply one hole per pixel as is the case in prior art registered collimators. Each of the embodiments may further comprise an imaging equipment arrangement including a pixelated detector having multiple pixel elements, in which the detector is operatively coupled to the collimator such that each group of collimator holes is registered with a respective one of the pixel elements. Further, the collimator of each embodiment may have a reduced height (e.g., about one-half or less) as compared to comparable conventional registered collimators that do not have the multiple-holes-per-pixel aspect described herein

### BRIEF DESCRIPTION OF THE DRAWINGS

FIG. 1 is an exploded perspective view of a collimator and an associated pixelated detector according to the prior art.

FIG. 2 is a plan view of the collimator and detector shown in FIG. 1.

FIG. 3 is a close-up view of the detector portion surrounded by dashed lines in FIG. 2.

FIG. 4 is a close-up view of the collimator portion surrounded by dashed lines in FIG. 2.

FIG. 5 is a plan view of a collimator and an associated pixelated detector according to a first embodiment of the present invention.

FIG. 6 is an alternative to the first embodiment shown in FIG. 5.

FIG. 7 is a close-up partial plan view of a collimator according to the first embodiment.

FIG. 8 is a close-up partial plan view of a collimator according to a second embodiment of the present invention.

FIG. 9 shows a comparison of cross-sectional side views of portions of collimator/detector pairings according to the prior art versus the first and second embodiments.

FIG. 10 is a perspective view of a collimator according to a third embodiment of the present invention.

FIG. 11 is a plan view of the third embodiment shown in FIG. 9.

FIG. 12 is a close-up partial plan view of the third embodiment.

FIG. 13 is a cross-sectional side view of a portion of a collimator according to the first embodiment.

FIG. 14 is a cross-sectional side view of a portion of a collimator according to the second embodiment.

FIG. 15 is a cross-sectional side view of a portion of a collimator according to the third embodiment.

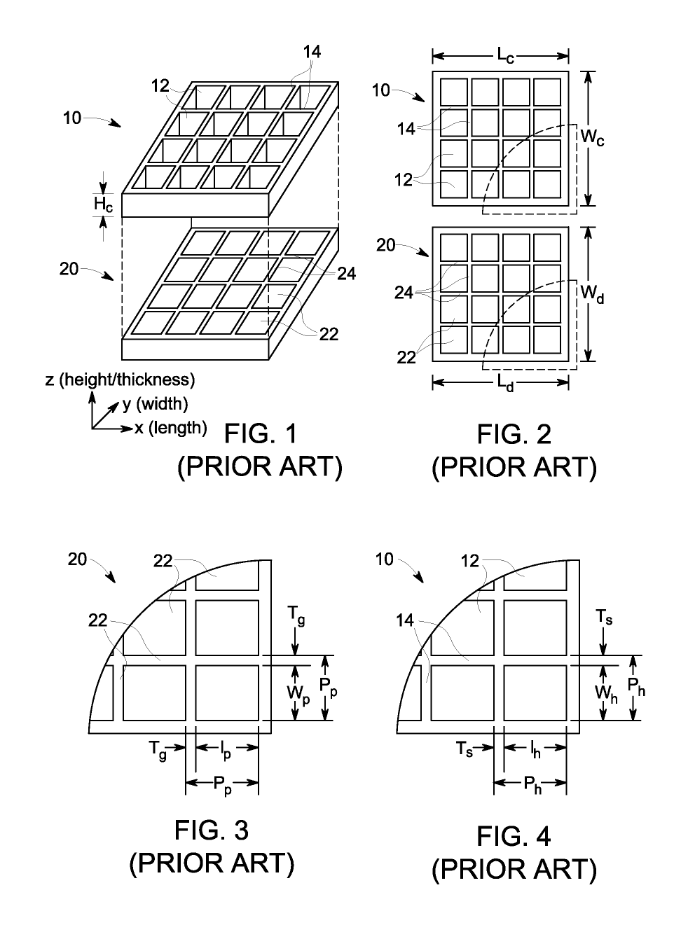

### DETAILED DESCRIPTION OF THE INVENTION

The foregoing summary, as well as the following detailed description of certain embodiments of the present invention, will be better understood when read in conjunction with the appended drawings. It should be understood that the various embodiments are not limited to the arrangements shown in the drawings.

As used herein, an element or step recited in the singular and proceeded with the word “a” or “an” should be understood as not excluding plural of said elements or steps, unless such exclusion is explicitly stated. Furthermore, any references to a particular embodiment of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments of the invention provide a collimator for collimating high-energy photons for use in performing molecular imaging of an anatomy or physiology of interest in a patient. A technical effect of the various embodiments is to provide a collimator that is configured to improve the sensitivity and/or resolution of a pixelated detector when used therewith. The collimator is also configured to help identify tumors or lesions during or after an imaging examination and optionally to facilitate performing a biopsy of the identified tumors or lesions in the anatomy of interest, such as in molecular breast imaging using one or more gamma cameras. An advantage of the various embodiments of the present invention is an improvement over the prior art approaches to the sensitivity-resolution tradeoff in designing collimators.

To assist the reader in understanding the embodiments of the present invention that are disclosed, all reference numbers used herein are summarized below, along with the elements they represent:
10 Collimator (prior art)
12 Hole
14 Septum
20 Pixelated detector
22 Pixel
24 Gap/spacing between pixels (air gap, potting, reflective material, etc.)
30 Collimator (first embodiment)
32 Hole
34 Group of holes
36 Intra-group septum (separating holes within a group)
38 Inter-group septum (separating one group from another)
40 Collimator (second embodiment)
42 Hole
44 Group of holes
46 Intra-group septum (separating holes within a group)
48 Inter-group septum (separating one group from another)
50 Collimator (third embodiment)
51 Top surface of the collimator
52 Hole
53 Bottom surface of the collimator
54 Group of holes
56 Intra-group septum (separating holes within a group)
58 Inter-group septum (separating one group from another)
L_{c} Overall length of collimator
W_{c} Overall width of collimator
H_{c} Overall height (thickness) of collimator
Tₛ Thickness of septum (in prior art collimators)
Tᵢₙₜₑᵣ Thickness of inter-group septum
Tᵢₙₜᵣₐ Thickness of intra-group septum
lₕ Length of collimator hole
wₕ Width of collimator hole
Pₕ Pitch of collimator holes
P_{g} Pitch of collimator groups
hₛ Height of intra-group septum
L_{d} Overall length of detector
W_{d} Overall width of detector
T_{g} Thickness of gap/spacing between detector pixels
lₚ Length of detector pixel
wₚ Width of detector pixel
Pₚ Pitch of detector pixels

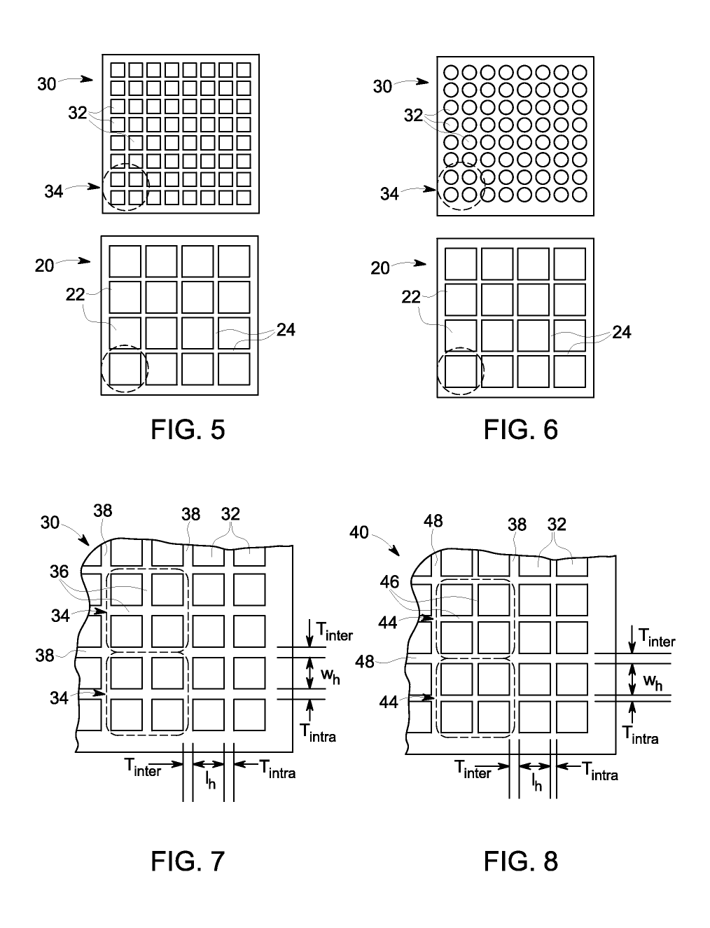

Referring now to the drawings, FIG. 5 shows a first embodiment of the present invention, in which a collimator 30 may be associated with a pixelated detector 20. While prior art collimators for use with pixelated detectors have one collimator hole or channel per detector pixel, embodiments of the present invention utilize multiple holes per pixel. The collimator 30 has holes 32 arranged in groups 34, wherein each group 34 corresponds in overall size and location to a respective detector pixel 22 on the detector 20. This creates unique one-to-one registrations between each one of the groups 34 of holes 32 and its respective associated pixel element 22. In other words, each group of holes aligns with only one pixel element, and each pixel element is aligned with only one group of holes. The collimator 30 may be placed over the detector 20 so that each detector pixel 22 is covered by a group 34 of collimator holes 32, with the centroid of each group 34 of holes 32 being generally projectively aligned with the center of its associated pixel 22. (As used here, “projectively” means as viewed along the line of projection between the target or ROI and each pixel element surface. This may be normal to a pixel element surface (as in the case of parallel hole collimators constructed according to the present invention) or oblique to the pixel surface (as in the case of at least some hole-pixel pairs in slanthole, converging, diverging, fan beam or cone beam collimators constructed according to the present invention). As shown in FIG. 5, each group may have four holes, but it may also have a different number N of holes where N is an integer greater than or equal to two. As also shown in FIG. 5, the holes may be square, or as shown in FIG. 6 they may be round, but they may also be formed in other shapes such as hexagonal, triangular, ovoid, rectangular, etc. The holes illustrated in FIG. 5 or 6 are all the same shape (i.e., either square or circular) and all the same size, and each group of holes is centered relative to its corresponding detector pixel; however, it is possible that a collimator according to an embodiment of the present invention may have some groups with one shape of hole (e.g., square) and other groups with a different shape of hole (e.g., round). Additionally, the sizes of the holes may be different for one group than another (thus offering the possibility that groups having smaller holes may optionally have more holes within that group). Furthermore, it is possible that one or more groups of holes may not be centered relative to its corresponding detector pixel. Moreover, the holes within one or more groups may differ from each other in size, shape and/or spatial orientation.

It may be easier to make and use a collimator fashioned according to an embodiment of the present invention wherein the holes are uniform within a group, and also uniform from group to group, in terms of shape, size and centeredness. However, there may be some applications where having different hole shapes, sizes and/or centeredness/orientations may be beneficial, such as when the collimator is designed for special applications where it may be desired to accept photons from a particular organ or region of interest differently from surrounding or nearby tissue. Also, there may be some detector arrangements (e.g., non-uniform distributions, shapes or sizes of pixels), some imaging procedures, and/or some reconstruction/calibration schemes or algorithms (e.g., utilizing differential photon acceptances) that are particularly well suited to using non-uniform hole shapes, sizes and/or centeredness/orientations within groups and/or from group to group as described above.

In the first embodiment illustrated by FIGS. 5-7, the holes 32 are shown as being evenly distributed; that is, the thickness of the septa separating adjacent holes 32 is uniform. This means that the thickness Tᵢₙₜᵣₐ of the septa between holes in a group (i.e., the intra-group septa 36) is generally equal to the thickness Tᵢₙₜₑᵣ of the septa between groups (i.e., the inter-group septa 38), or Tᵢₙₜᵣₐ Tᵢₙₜₑᵣ. FIG. 8 shows an alternative, second embodiment 40 in which the intra-group septa 46 separating the holes 42 within each group 44 have a thickness Tᵢₙₜᵣₐ which is smaller than the thickness Tᵢₙₜₑᵣ of the septa 48 separating each group 44, or Tᵢₙₜᵣₐ<Tᵢₙₜₑᵣ. In this second embodiment 40, the septa 48 which separate each group 44 of holes 42 may have the same thickness Tᵢₙₜₑᵣ as that of the septa 38 which separate each group 34 of holes 32 in the first embodiment 30; however, in the second embodiment 40, the septa 46 which separate the holes 42 within each group 44 has a smaller thickness Tᵢₙₜᵣₐ than that of the septa 36 which separate the holes 32 within each group 34 in the first embodiment 30. In other words, the first and second embodiments as viewed in FIGS. 7 and 8 are generally similar, except that the intra-group septa 46 of the second embodiment 40 are thinner than the intra-group septa 36 of the first embodiment 30.

Because of the thinner intra-group septa 46 in the second embodiment 40, the collective area of all the holes 42 in each group 44 is larger than the collective area of all the holes 32 in each group 34 in the first embodiment 30, thereby providing more photons to each detector pixel than would be the case for the first embodiment 30 at constant collimator resolution.

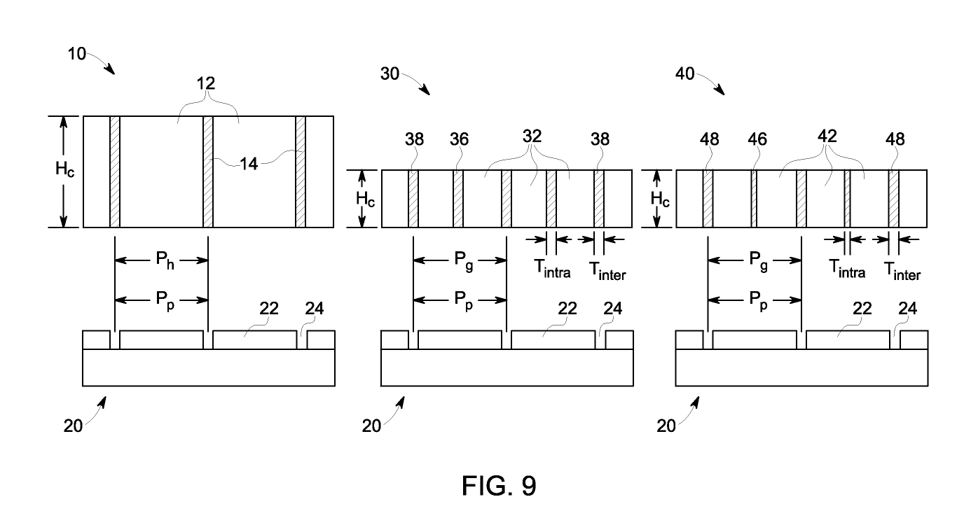

In both the first and second embodiments 30/40, the individual holes or channels 32/42 have dimensions (e.g., lₕ and wₕ for square/rectangular holes, diameter for round holes, area, etc.) which are one-half of or even smaller than the dimensions of holes 12 found in typical prior art registered collimators 10. Because these individual holes 32/42 are smaller, the overall height/thickness H_{c} of the collimator 30/40 can also be smaller than comparable conventional prior art registered collimators 10 (e.g., on the order of about one-half or less), while still maintaining generally the same aspect ratio (i.e., the ratio of collimator height H_{c} to hole dimension). (A comparable conventional registered collimator used with a pixelated detector, as compared to a collimator constructed according to the present invention used with that same pixelated detector, would be a similar type of collimator (e.g., parallel hole) having a comparable aspect ratio (i.e., ±10%), but having a one-to-one registration between its holes and the detector's pixels, as opposed to the multiple-smaller-holes-per-pixel arrangement of the present invention.) This is illustrated in FIG. 9, which shows a prior art collimator 10 compared to collimators constructed according to the first and second embodiments 30/40. Each of the three collimators shown in FIG. 9 is registered to a pixelated detector 20 having a pixel pitch Pₚ. The prior art collimator 10 has septa 14 forming holes 12 having a hole pitch Pₕ which matches the pixel pitch Pₚ. The first and second embodiments 30/40 are registered to detectors 20 having the same pitch Pₚ to which the prior art collimator 10 is registered, and the inter-group septa 38/48 of the first and second embodiments 30/40 form groups 34/44 of holes 32/42, wherein the pitch between adjacent groups is P_{g}, which matches the pixel pitch Pₚ. Although it is not a requirement that the first and second embodiments 30/40 be constructed with a reduced height H_{c} as described above, it may be advantageous to do so to preserve the aspect ratio of the holes and thereby preserve the usual resolution and thus use embodiments of the present invention to increase sensitivity without loss in resolution and thereby overcome the prior art limitations on resolution-sensitivity tradeoff. In addition, it may be advantageous to have a smaller height H_{c} in order to reduce weight and cost, and to enable positioning of the detector closer to the patient or region of interest.

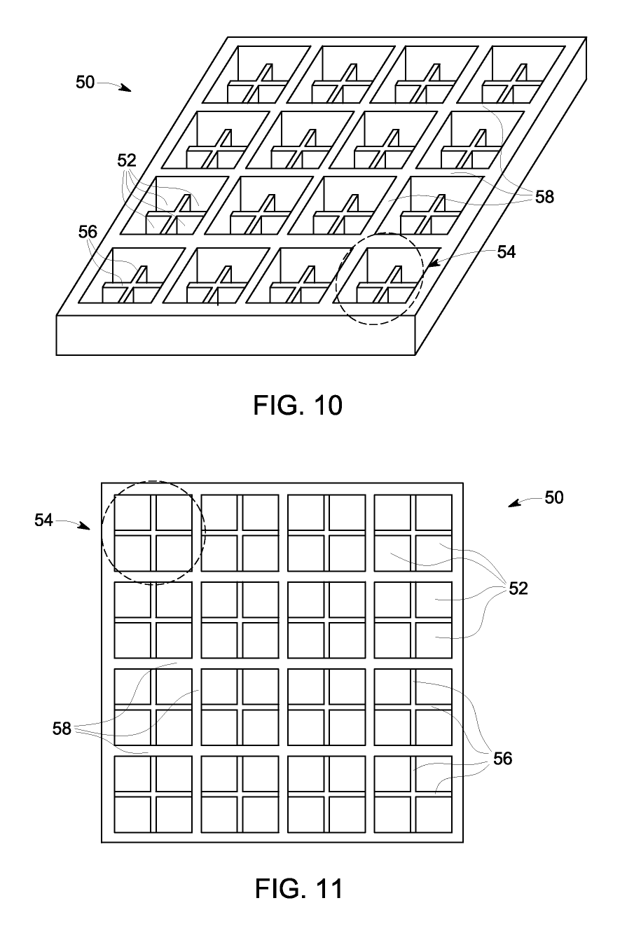

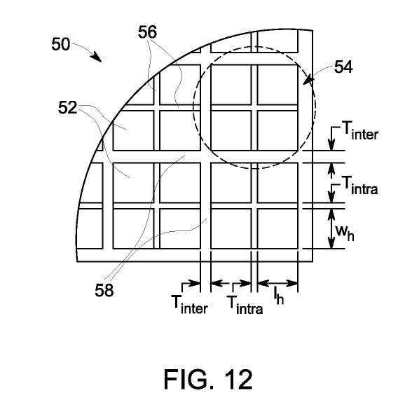

A third embodiment of the present invention is shown in FIGS. 10-12. In this embodiment, the intra-group septa 56 are recessed from the top and/or bottom surface of the collimator such that the height hₛ of these septa 56 is less than the overall height H_{c} of the collimator 50. It should be noted that although FIG. 10 only shows these septa 56 as being recessed from the “top” surface, it is equally within the scope of the present embodiment that the intra-group septa 56 can be recessed from the other (“bottom”) surface of the collimator, or from both surfaces. In a configuration according to this embodiment, the overall height H_{c} of the collimator can be the same as that of an otherwise conventional collimator, or it can be made smaller. Also, although FIGS. 10-12 show the thickness Tᵢₙₜᵣₐ of the intra-group septa 56 as being smaller than the thickness Tᵢₙₜₑᵣ of the inter-group septa 58, it is within the scope of this embodiment that these thicknesses (Tᵢₙₜᵣₐ and Tᵢₙₜₑᵣ) can optionally be the same.

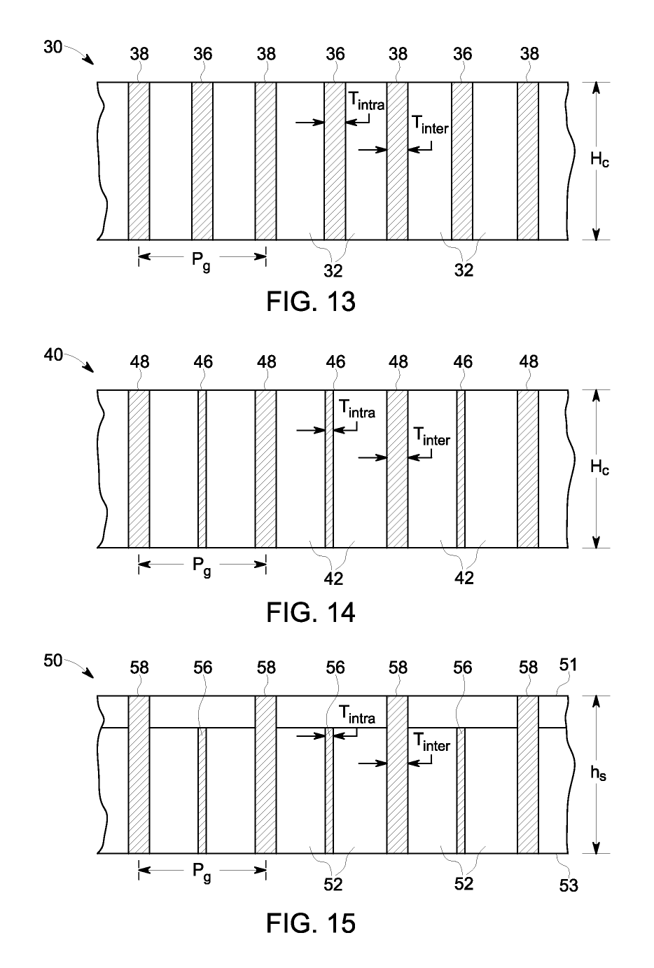

For the sake of comparison, FIGS. 13-15 show cross-sections of the first, second and third embodiments 30/40/50. Each of the three embodiments illustrates the use of four holes per group (i.e., a 2×2 matrix of holes per group and per pixel), of which two holes per group are shown in each cross-section. The first embodiment 30 in FIG. 13 shows the use of uniform septa 36/38 throughout the collimator, wherein the thickness Tᵢₙₜᵣₐ of the intra-group septa 36 is equal to the thickness Tᵢₙₜₑᵣ of the inter-group septa 38. The second embodiment 40 in FIG. 14 shows the use of a reduced thickness Tᵢₙₜᵣₐ for the intra-group septa 46 which is less than the thickness Tᵢₙₜₑᵣ of the inter-group septa 48. The third embodiment 50 shown in FIG. 15 shows the use of recessed intra-group septa 56 which are shown here as being recessed from the top surface 51 of the collimator 50. As mentioned above, in the third embodiment 50 the intra-group septa 56 may be recessed from the top surface 51, the bottom surface 53, or both, and the intra-group septa 56 may have a thickness Tᵢₙₜᵣₐ which is less than the thickness Tᵢₙₜₑᵣ of the inter-group septa 58, or it may be the same.

Simulations were conducted using various configurations of the three embodiments compared against known prior art collimators. The results of these comparisons are shown below in TABLES 1 and 2. Rows 1 and 2 describe two actual collimators known in the art: one used by Gamma-Medica (designated as “GM actual”) and another by GE Healthcare (designated as “GE actual”). As shown in Row 1, the GM collimator is used with a pixelated detector having a pixel pitch of 1.6 mm, and is constructed out of tungsten (W). This collimator has a height H_{c} of 9.4 mm and uses septa that are 0.38 mm in thickness, providing a sensitivity of 1972 cpm/μCi, a FWHM resolution at 3.0 cm of 5.061 mm, and a septal penetration of 1.44%. As shown in Row 2, the GE collimator is used with a pixelated detector having a pixel pitch of 2.46 mm, and is constructed out of lead (Pb). This collimator has a height H_{c} of 21.0 mm and uses septa that are 0.40 mm in thickness, providing a sensitivity of 1267 cpm/μCi, a FWHM resolution at 3.0 cm of 4.800 mm, and a septal penetration of 0.87%. Using the sensitivity of the GM collimator as a standard (i.e., Relative Sensitivity (RS)=1.00), it can be seen that the GE collimator has a RS of 0.64 as compared to the GM collimator.

Rows 3-6 show known ways in which the GE collimator of Row 2 could be modified to match the resolution and septal penetration of the GM collimator of Row 1. Choosing 5.000 mm and 5.100 mm as two target values for the resolution (i.e., just a little above and below the 5.061 mm GM resolution), it can be seen in Rows 3 and 4 that simply lowering the collimator height H_{c} to 19.8 mm and 18.8 mm, respectively, would meet the two target values. Alternatively, rows 5 and 6 show that the same performance can be achieved with tungsten, namely switching from lead to tungsten, and making the septum thickness (Tᵢₙₜₑᵣ) smaller, would also meet the two resolution targets. However, none of these modifications in rows 3-6 raises the sensitivity up to the chosen standard of the GM collimator.

By contrast, rows 7 and 8 describe a collimator designed according to the first embodiment of the present invention, wherein not one but four collimator holes per detector pixel are provided. Keeping the same 2.46 mm pixel pitch as used with the GE collimator of row 2, and using tungsten as the detector material, rows 7 and 8 indicate that the collimator height H_{c} can be dramatically reduced (down to the range of 6.1 to 6.4 mm), while maintaining the collimator's original septum thickness of 0.40 mm and still meeting the 5.000 or 5.100 mm resolution criteria. Moreover, the sensitivities achieved by these modifications are generally better than those achieved by the known approaches of rows 3-6, while still maintaining excellent septal penetration and the required resolution.

Rows 9 and 10 show modifications made according to the second embodiment, in which the collimator also uses four holes per pixel, but also includes reducing the intra-group septum thickness Tᵢₙₜᵣₐ to 0.025 mm. This allows the inter-group septum thickness Tᵢₙₜₑᵣ to be reduced, while still maintaining a thin collimator (i.e., very low H_{c}) with high sensitivity and low septal penetration. Rows 11 and 12 show the intra-group septum thickness Tᵢₙₜᵣₐ being further reduced to 0.020 mm, which enables the inter-group septum thickness Tᵢₙₜₑᵣ and collimator height H_{c} to remain about the same as rows 9 and 10, but with improved sensitivity compared to rows 9 and 10.

TABLE 1

| | | | | Inter-group | | | | | Intra-group | |
|---|---|---|---|---|---|---|---|---|---|---|
| | Pixel | | Collimator | Septum | | | Resolution | | Septum | |
| | Pitch, | | Height, | Thickness, | | Relative | FWHM | | Thickness, | |
| Row | Pₚ | | H_{c} | Tᵢₙₜₑᵣ | Sensitivity | Sensitivity, | @ 3.0 cm | Septal | Tᵢₙₜᵣₐ | |
| # | (mm) | Material | (mm) | (mm) | (cpm/μCi) | RS | (mm) | Penetration | (mm) | Comments |
| 1 | 1.6 | W | 9.4 | 0.38 | 1972 | 1.00 | 5.061 | 1.44% | N/A | GM actual |
| 2 | 2.46 | Pb | 21.0 | 0.40 | 1267 | 0.64 | 4.800 | 0.87% | N/A | GE actual |
| 3 | 2.46 | Pb | 19.3 | 0.40 | 1511 | 0.766 | 4.999 | 1.28% | N/A | Lower GE height to |
| 4 | 2.46 | Pb | 18.8 | 0.40 | 1596 | 0.809 | 5.090 | 1.44% | N/A | match GM resolution |
| 5 | 2.46 | W | 21.2 | 0.27 | 1557 | 0.790 | 4.963 | 1.52% | N/A | Switch to W and |
| 6 | 2.46 | W | 20.1 | 0.29 | 1675 | 0.850 | 5.092 | 1.38% | N/A | smaller septa |
| 7 | 2.46 | W | 6.4 | 0.40 | 1636 | 0.830 | 4.996 | 1.50% | N/A | 4 holes per pixel |
| 8 | 2.46 | W | 6.1 | 0.41 | 1667 | 0.845 | 5.096 | 1.49% | N/A | |
| 9 | 2.46 | W | 7.6 | 0.35 | 1762 | 0.894 | 4.991 | 1.40% | 0.025 | 4 holes per pixel + |
| 10 | 2.46 | W | 7.4 | 0.35 | 1837 | 0.932 | 5.083 | 1.47% | 0.025 | Tᵢₙₜᵣₐ = 0.025 mm |
| 11 | 2.46 | W | 7.8 | 0.34 | 1898 | 0.963 | 4.987 | 1.46% | 0.020 | 4 holes per pixel + |
| 12 | 2.46 | W | 7.5 | 0.35 | 1981 | 1.005 | 5.099 | 1.40% | 0.020 | Tᵢₙₜᵣₐ = 0.020 mm |

TABLE 2 shows a further set of simulations involving the second embodiment. In this set, the 0.246 pixel pitch, tungsten collimator material, and resolution targets of 5.000 and 5.100 mm were maintained, while the intra-group septum thickness Tᵢₙₜᵣₐ was iterated from 0.015 mm (rows A and B), to 0.020 mm (rows C and D), and then to 0.025 mm (rows E and F). It may be noted that rows C and D have the same measurements as rows 11 and 12 in TABLE 1 (both having Tᵢₙₜᵣₐ=0.020 mm), and that rows E and F have the same measurements as rows 9 and 10 (both having Tᵢₙₜᵣₐ=0.025 mm); however, TABLE 2 also includes results for the Intra-group Septum Penetration, or IGSP, which is an estimation of how often along the intra-group septa 46 gamma photons penetrate before being absorbed. In these iterations, it was desired to find the design that had the highest sensitivity, while keeping the IGSP below 15%. This value is chosen to get 90% of the entitlement, and may be further optimized; it also shows that the GM collimator performance standard may be exceeded. TABLE 2 shows that while rows A and B had the best set of sensitivities, the IGSP values were unacceptably high. The design in rows E and F showed acceptable IGSP values, but their sensitivities were lower than those of rows C and D, which also had acceptable IGSPs. Thus, either of the designs in rows C and D (utilizing an intra-group septum thickness of Tᵢₙₜᵣₐ=0.020 mm) would be a good choice, given the requirements presented.

TABLE 2

| | | | | Inter-group | | | | | Intra-group | | |
|---|---|---|---|---|---|---|---|---|---|---|---|
| | Pixel | | Collimator | Septum | | | Resolution | | Septum | Intra-group | |
| | Pitch, | | Height, | Thickness, | | Relative | FWHM | | Thickness, | Septum | |
| Row | Pₚ | | H_{c} | Tᵢₙₜₑᵣ | Sensitivity | Sensitivity, | @ 3.0 cm | Septal | Tᵢₙₜᵣₐ | Penetration, | |
| # | (mm) | Material | (mm) | (mm) | (cpm/μCi) | RS | (mm) | Penetration | (mm) | IGSP | Comments |
| A | 2.46 | W | 7.9 | 0.34 | 2036 | 1.032 | 4.997 | 1.36% | 0.015 | 17.60% | IGSP too high |
| B | 2.46 | W | 7.7 | 0.34 | 2127 | 1.079 | 5.088 | 1.49% | 0.015 | 18.20% | IGSP too high |
| C | 2.46 | W | 7.8 | 0.34 | 1898 | 0.963 | 4.987 | 1.46% | 0.020 | 5.10% | Good choice |
| D | 2.46 | W | 7.5 | 0.35 | 1981 | 1.005 | 5.099 | 1.40% | 0.020 | 10.40% | Good choice |
| E | 2.46 | W | 7.6 | 0.35 | 1762 | 0.894 | 4.991 | 1.40% | 0.025 | 5.40% | Sensitivity low |
| F | 2.46 | W | 7.4 | 0.35 | 1837 | 0.932 | 5.083 | 1.47% | 0.025 | 5.80% | Sensitivity low |

An analysis for the third embodiment 50, utilizing a similar approach as that described for the second embodiment 40, indicates that a reduced intra-septum height hₛ of about 80% of the overall collimator height is a good choice. (That is, hₛ is about 0.8 H_{c}.)

As those skilled in the art will appreciate, the sensitivity, resolution and septal penetration/IGSP (SP) figures used in TABLES 1 and 2 may be calculated as follows:

Sensitivity=(0.28h²/Pₚ/Hₑ)² (1)

Resolution=Pₚ(Hₑ+b)/Hₑ+Tᵢₙₜᵣₐ (2)

SP=e^{-μW} (3)

where

h=(Pₚ−Tᵢₙₜₑᵣ−Tᵢₙₜᵣₐ)/2 (4)

and

Hₑ=H_{c}−2/μ, (5)

and

W≈tH_{c}/(2h+t) (6)

In these equations, h represents the hole size, b is the source-to-collimator distance, μ is the linear attenuation coefficient for the collimator material (μ=34/cm for tungsten), W is the shortest path length for gamma rays to travel through a septum from one hole to the next, t is the thickness of the septum which the gamma rays pass through (i.e., Tᵢₙₜₑᵣ or Tᵢₙₜᵣₐ, as the case may be), and Hₑ is the effective height of the collimator (which has been reduced from the full length H_{c} due to septum penetration at both ends of the holes). The coefficient 0.28 in Eqn. (1) is a geometrical factor used for square holes.

If desired, two or more of the embodiments may be combined together. For example, the second embodiment 40 (which has intra-group septa 46 that are thinner than the inter-group septa 48) may be combined with the third embodiment 50 (which has intra-group septa 56 that are recessed from the top and/or bottom surface of the collimator thereby making them “shorter” than the inter-group septa 58). In such a combination, the intra-group septa designated in the drawings as elements 46 and 56 would be the same structure having the characteristics of both embodiments (i.e., the intra-group septa 46/56 would be both thinner and “shorter” than the inter-group septa 48/58). Other combinations of the embodiments 30/40/50 are also possible and within the scope of the present invention.

For those seeking further explanation of the collimator concepts used in this disclosure, the following references are suggested, all of which are incorporated herein by reference as if fully set forth herein: (1) http://www.nuclearfields.com/collimators-designs.htm; (2) http://www.nuclearfields.com/collimators-nuclear-medicine.htm; (3) Physics in Nuclear Medicine, Third Edition, by Simon R. Cherry, James A. Sorenson and Michael E. Phelps (W.B. Saunders Co.); and (4) Design of optimal collimation for dedicated molecular breast imaging systems, by Amanda L. Weinmann, Carrie B. Hruska and Michael K. O'Connor, Med. Phys. 36, pp. 845-856 (2009).

The above description is intended to be illustrative, and not restrictive. While the invention has been described in terms of various specific embodiments, those skilled in the art will recognize that the invention can be practiced with modification within the spirit and scope of the claims. For example, the above-described embodiments (and/or aspects thereof) may be used in combination with each other. In addition, a collimator according to the present invention may include the multiple-collimator-holes-per-detector pixel arrangement applied to only a portion of the overall collimator structure (e.g., corresponding to a particular organ or region of interest), with adjacent or other collimator structure conforming to the conventional one-hole-per-pixel arrangement. Moreover, many modifications may be made to adapt a particular situation or material to the teachings of the invention without departing from its scope. While the dimensions and types of materials described herein are intended to illustrate the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the invention, including the best mode, and also to enable those skilled in the art to practice the invention, including making and using any devices or systems thereof and performing any methods thereof. It is the following claims, including all equivalents, which define the scope of the present invention.

1. A registered collimator having holes therein arranged in groups, wherein the holes within each group are separated by intra-group septa having a first thickness Tᵢₙₜᵣₐ and said groups are separated from one another by inter-group septa having a second thickness Tᵢₙₜₑᵣ, said collimator being adapted for use with a pixelated detector having multiple pixel elements such that each of said groups of holes may be registered with a respective one of the pixel elements.

2. A registered collimator according to claim 1, wherein said collimator may be operatively coupled with a pixelated detector having multiple pixel elements such that multiple holes are registered with each pixel element.

3. A registered collimator according to claim 1, wherein Tᵢₙₜᵣₐ=Tᵢₙₜₑᵣ.

4. A registered collimator according to claim 1, wherein Tᵢₙₜᵣₐ<Tᵢₙₜₑᵣ.

5. A registered collimator according to claim 1, wherein said collimator has a top surface, a bottom surface and an overall height H_{c} extending between said surfaces, and wherein said intra-group septa have a height hₛ and are recessed from said top surface and/or said bottom surface such that hₛ<H_{c}.

6. A registered collimator according to claim 5, wherein hₛ is about 0.8 H_{c}

7. A registered collimator according to claim 1, wherein each group of holes comprises four holes arranged in a 2×2 array.

8. A registered collimator according to claim 1, wherein said collimator has a top surface, a bottom surface and an overall height H_{c} extending between said surfaces, and wherein the overall height H_{c} of said collimator is about half or less than the height of a comparable conventional registered collimator.

9. An imaging equipment arrangement according to claim 1, further comprising a pixelated detector having multiple pixel elements, wherein said detector is operatively coupled to said collimator such that each group of holes is registered with a respective one of the pixel elements.

10. An imaging equipment arrangement according to claim 9, wherein each group of holes is projectively centered with respect to its associated pixel.

11. A collimator having holes therein arranged in groups and having a top surface, a bottom surface and an overall height H_{c} extending between said surfaces, wherein the holes within each group are separated by intra-group septa having a first thickness Tᵢₙₜᵣₐ and wherein said groups are separated from one another by inter-group septa having a second thickness Tᵢₙₜₑᵣ, said collimator being adapted for use with a pixelated detector having multiple pixel elements such that each of said groups of holes may be registered with a respective pixel element when said collimator is operatively coupled with the pixelated detector, and wherein Tᵢₙₜᵣₐ<Tᵢₙₜₑᵣ.

12. A collimator according to claim 11, wherein the overall height H_{c} of said collimator is about one-half or less than the height of a comparable conventional registered collimator.

13. A collimator according to claim 11, wherein said intra-group septa have a height hₛ and are recessed from said top surface and/or said bottom surface such that hₛ<H_{c}.

14. A collimator according to claim 13, wherein hₛ is about 0.8 H_{c}.

15. An imaging equipment arrangement according to claim 11, further comprising a pixelated detector having multiple pixel elements, wherein said detector is operatively coupled to said collimator such that each group of holes is registered with a respective one of the pixel elements.

16. A collimator having a top surface, a bottom surface and an overall height H_{c} extending between said surfaces, said collimator having holes therein arranged in groups, wherein the holes within each group are separated by intra-group septa and said groups are separated from one another by inter-group septa, said collimator being adapted for use with a pixelated detector having multiple pixel elements such that each of said groups of holes may be registered with a respective pixel element when said collimator is operatively coupled with the pixelated detector, said intra-group septa having a height hₛ and being recessed from said top surface and/or said bottom surface such that hₛ<H_{c}.

17. A collimator according to claim 16, wherein hₛ is about 0.8 H_{c}.

18. A collimator according to claim 16, wherein said intra-group septa have a first thickness Tᵢₙₜᵣₐ and said inter-group septa have a second thickness Tᵢₙₜₑᵣ, such that Tᵢₙₜᵣₐ<Tᵢₙₜₑᵣ.

19. A collimator according to claim 16, wherein said collimator has a top surface, a bottom surface and an overall height H_{c} extending between said surfaces, and wherein the overall height H_{c} of said collimator is about one-half or less than the height of a comparable conventional registered collimator.

20. An imaging equipment arrangement according to claim 16, further comprising a pixelated detector having multiple pixel elements, wherein said detector is operatively coupled to said collimator such that each group of holes is registered with a respective one of the pixel elements.
